(19) United States
(12) Patent Application Publication
(10) Pub. No.: US 2013/0191523 A1
(43) Pub. Date: Jul. 25, 2013

(54) REAL-TIME ANALYTICS FOR LARGE DATA SETS

(71) Applicants: Leonard Jerome Buck, Chapel Hill, NC (US); Charles Boyd Burnette, Wake Forest, NC (US); Joseph Patrick Davy, Durham, NC (US); Alexey Alexeyevich Melnichenko, Raleigh, NC (US)

(72) Inventors: Leonard Jerome Buck, Chapel Hill, NC (US); Charles Boyd Burnette, Wake Forest, NC (US); Joseph Patrick Davy, Durham, NC (US); Alexey Alexeyevich Melnichenko, Raleigh, NC (US)

(73) Assignee: EvoApp, Inc., Durham, NC (US)

(21) Appl. No.: 13/552,435

(22) Filed: Jul. 18, 2012

Related U.S. Application Data
(60) Provisional application No. 61/588,501, filed on Jan. 19, 2012.

(51) Int. Cl. G06F 15/173

(52) U.S. Cl. 709/223

(57) ABSTRACT

A cloud computing system is described herein that enables fast processing of queries over massive amounts of stored data. The system is characterized by the ability to scan tens of billions of data items and to perform aggregate calculations like counts, sums, and averages in real-time (less than three seconds). Ad hoc queries are supported including grouping, sorting, and filtering without the need to predefine queries by providing highly efficient loading and processing of data items across an arbitrarily large number of processors. The system does not require any fixed schema, thus the system supports any type of data. Calculations made to satisfy a query may be distributed across a large number of processors to parallelize the work. In addition, an optimal blob size for storing multiple serialized data items is determined, and existing blobs that are too large or too small are proactively redistributed or coalesced to increase performance.

### BACKGROUND OF THE INVENTION

Cloud computing provides users with computing resources (storage, computation power, communications bandwidth, etc.) on demand, i.e., shared resources are allocated by a cloud infrastructure provided to various “tenants” users or processes, and the tenants might be charged accordingly. This releases users from the burden of maintaining their own hardware, determining the right amount of hardware and keeping it occupied.

Cloud computing systems like Windows Azure and Amazon S3 provide foundational tools such as compute power and raw storage, but by themselves they do not provide the capability to analyze extremely large sets of data in near real time. Performing a query on an extremely large data set would be too slow. Computation in real-time is limited to operate over much smaller data sets. For a sufficiently small data set size, in the tens of thousands of data items, standard SQL databases can perform these computations quickly enough. However, in order for a SQL database to achieve these near real-times responses even with a small data set size, a large amount of indexing must be maintained during data insertion, severely limiting write throughput.

Even when using indexing to speed performance of data lookups, performing intensive calculations with tens of billions of data items using a conventional system may be done using batch-style processing, wherein a request is made, and then the user or process waits for a result, which can take sufficiently long that the user or process might move on to do something else while waiting for the response.

Having a large number of processor to apply to processing a request, cloud computing might provide parallel computation to allow for faster responses, but enabling parallel computation still requires some planning ahead of time. One current practice in the industry is to use a map-reduce batch system such as Hadoop to perform predetermined queries across large data sets (with the data frequently coming from SQL databases) and store the results in a key/value store, such as MongoDB or Cassandra, for quick retrieval. Hadoop and similar tools are engineered for crunching through vast amounts of data over minutes or hours, calculating predetermined queries and producing file output. These systems are primarily batch systems and have a large job startup cost. Key-value stores like Cassandra are engineered to hold large data sets and provide constant time access to any value given its key. Even though these key-value stores can hold large amounts of data, these systems are slow at performing scanning computations over tens of billions of data items.

Thus, improvements are desirable.

### SUMMARY

The approaches described herein are directed to enable fast processing of queries over massive amounts of data stored in a cloud computing system. The resulting system is characterized by the ability to scan tens of billions of data items and perform aggregate calculations like counts, sums, and averages in real-time (less than three seconds). The term “data item” is used herein to mean a record of data containing values for attributes describing an event or other real-world entity (person, place, thing, etc.). Ad hoc queries are supported including grouping, sorting, and filtering without the need to predefine queries because, unlike traditional relational database systems, there is no schema. Thus, the system supports any type of data. Calculations made to satisfy a query may be distributed across a large number of processors in order to parallelize the work. The system provides very fast write performance to get data into the system without impacting read performance.

System and application designers often need to decide how best to make the tradeoff between storage and processing. Traditionally, storage has been more expensive than processing so very large systems have sought to minimize storage and utilize more processing power such as a multi-processor system or cluster. The potentially large number of data items found through indexing may not be co-resident on the storage device, which could introduce additional time to perform I/O when retrieving the data into memory.

In a cloud system, however, storage may be considered inexpensive. One aspect of the approach described herein is that rather than creating an index for each of the data views such as is done in SQL database systems, each data item is replicated and physically stored together on the storage device in a view. Thus, rather than having to use an index to find the data to scan, the data may already be co-located with data having similar values in the same dimension.

In addition to the storage cost, another reason why traditional SQL databases tend not to replicate data is the expense incurred to keep multiple copies of data synchronized when changing a data value. Another characterizing feature of this approach is that data values are immutable, and keys can be updated quickly and atomically. Thus, appending new data items into a view does not require updating previously stored replicated data. For a system processing primarily write-once data, such as logged events, previously stored data is rarely changed. Although the system as described herein is capable of changing values of previously stored data, such changes are an infrequent operation, and thus, updating values of data replicas tends not to degrade the overall performance of the system.

What follows are several examples of queries that may be performed on data sets having the characteristics described above. In one example a system storing roughly 10 billion tweets (i.e., Twitter messages) are to be data mined. Each tweet contains a timestamp, location indicator, and a text message. Each tweet may be stored in a data view corresponding to each of the dimensions of time, geolocation (also referred to herein as “location”), and a dimension for certain keywords. A query may be received to count the number of tweets from the state of Nevada between Christmas 2011 and New Years Day of 2012 that mention “drought”.

In another example, a system storing weather data from 2000 weather stations across the U.S. is to be mined. Each data item may contain a timestamp, location indicator, and temperature reading. Two data views may be supported: time and location. A query is received to find the average temperature for each week of 2011 at each weather station.

In yet another example, a system storing stock price data from every listing on the NASDAQ is to be mined. Each data item may contain a timestamp, ticker symbol, and price. Two data views may be supported: time and ticker symbol. A query may be received to find the highest price that a stock represented by ticker symbol AAPL has ever traded for through Dec. 31, 2011.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a simplified functional block diagram of an embodiment of a cloud computing system.

FIG. 2 is a simplified functional block diagram illustrating the relationship between collections of data items stored in remote network storage and objects stored in memory.

FIG. 3a is a simplified functional block diagram of an embodiment of a cloud computing system receiving an external query.

FIG. 3b is a simplified functional block diagram of an embodiment of an initiating node in a cloud computing system distributing work to other processing nodes for evaluating an external query.

FIG. 3c is a simplified functional block diagram of an embodiment of processor nodes in a cloud computing system retrieving data for performing the work assigned by the initiating processor node.

FIG. 3d is a simplified functional block diagram of an embodiment of processor nodes in a cloud computing system sending results of the work performed on each node back to the initiating node.

FIG. 3e is a simplified functional block diagram of an embodiment of an initiating node in a cloud computing system collecting results from each processor node, merging these results, and returning query results in response to an external query.

FIG. 4a is a simplified functional block diagram of an embodiment of a collection descriptor representing a chunk comprising two value blobs.

FIG. 4b is a simplified functional block diagram of an embodiment of combining the contents of two value blobs into one new value blob.

FIG. 4c is a simplified functional block diagram of an embodiment of updating the key to point to the new value blob.

FIG. 5 is a simplified functional block diagram of an embodiment of a key with multiple versions.

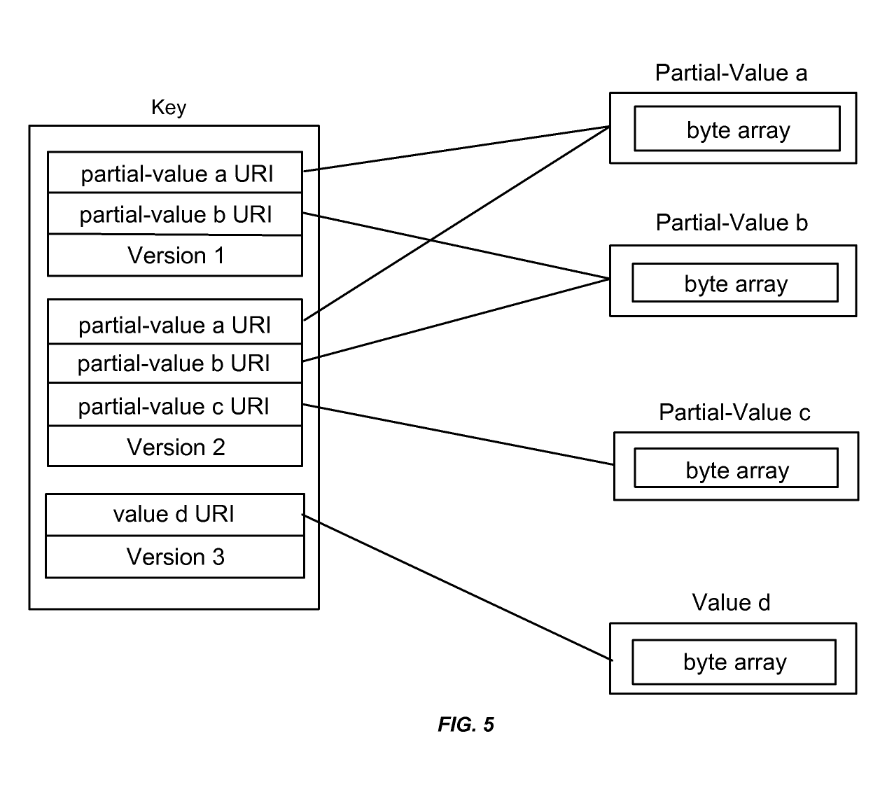

FIG. 6 is a simplified functional block diagram of an embodiment of storing a separate copy of a new data item into a date view and a location view.

FIG. 7 is a simplified functional block diagram of an embodiment of naming a key to point to a newly stored data item.

FIG. 8a is a simplified functional block diagram of an embodiment of generating and storing a de-serialization library from a description of a data item type.

FIG. 8b is a simplified functional block diagram of an embodiment of a compute node retrieving a de-serialization library from persistent storage, and loading the library into the compute node memory.

FIG. 8c is a simplified functional block diagram of an embodiment of using the de-serialization library to de-serialize a serialized data item from persistent storage into memory.

FIG. 9 is a simplified functional block diagram showing an overview of components of a cloud computing system according to an embodiment.

FIG. 10 is a simplified functional block diagram of an embodiment of a computing system on which the techniques herein may be implemented.

### DETAILED DESCRIPTION OF THE INVENTION

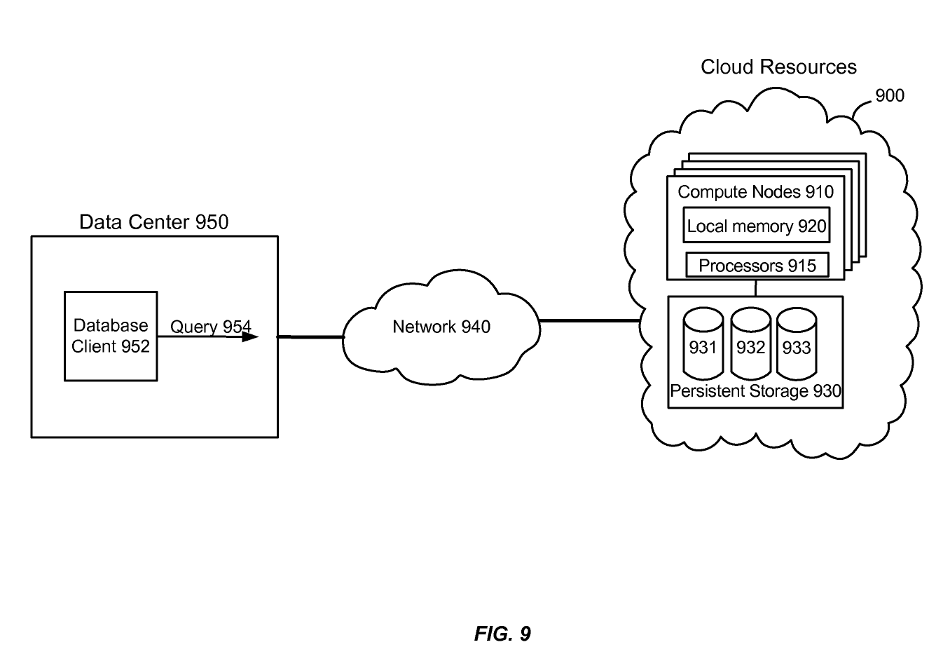

FIG. 9 is a simplified functional block diagram showing an overview of components of a cloud computing system according to an embodiment. The cloud computing system is comprised of cloud resources 900 that includes a set of compute nodes 910, each of which includes one or more processors 915 and local memory 920. The compute nodes 910 are coupled to persistent storage 930 comprising a collection of storage devices, for example, storage devices 931, 932, and 933. The cloud computing system 900 receives query 954 over network 940 from database client 952 residing within data center 950.

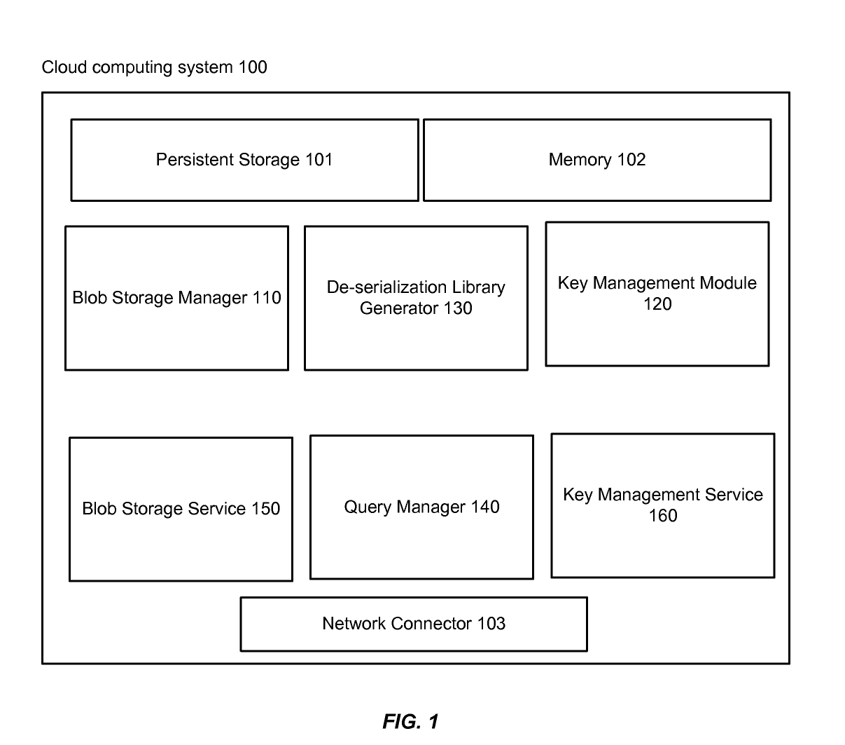

FIG. 1 is a simplified functional block diagram of an embodiment of a cloud computing system. Cloud computing system 100 includes functional modules comprising persistent storage 101, memory 102, network connector 103, blob storage manager 110, blob storage service 150, key management module 120, key management service 160, query manager 140, and de-serialization library generator 130.

Persistent Storage 101 comprises disk drives collectively storing data in serialized binary form. The persistent storage system does not impose a schema on the data that is stored within, thus the data is stored in blobs unstructured. The data may be of any named type provided that the type is defined in a data type specification known to the system, and the data stored in blobs need not provide structure information. From the perspective of Persistent Storage 101, the structure of the data managed within is unknown. The persistent storage may comprise disk storage units with a local interconnect with the cluster of nodes or a remote storage service. Although the examples depict the use of remote network storage, it is not required that the persistent storage be remote from the computing nodes.

Memory 102 is smaller than persistent storage 101 and serves as a cache for certain persistently-stored data. Memory 102 provides faster access to de-serialized data. When data is read into memory from persistent storage, the binary encoded data is decoded, and the data assumes the proper structure. This process may also be called instantiation or inflation of the data. Memory may be volatile RAM, disk, or any other type of read/write memory.

Network Connector 103 connects the cloud computing system 100 to the external systems that send work requests to the cloud. A query may be received from an external system over the network connector and results sent back to the requesting system over the network. The cloud may be connected over the Internet, a private wide area network, metropolitan area network, or local area network.

A data item may undergo a serial encoding for storing persistently. Thus, a data item stored in the persistent storage system may be referred to herein as a serialized data item. Blob storage manager 110 manages the storage of serialized data items in blobs within persistent storage 101. Blob storage manager packages data items into value blobs in persistent storage to optimize performance. Because the system may be used to compute aggregate values across tens of billions of data items, the data items need to be packaged into optimized chunks based on chunking strategies. The term “chunk” is used herein to mean an aggregation of related value blobs where the chunk is identified by a key. The key identifying a chunk may be said to point to each of the value blobs in the aggregation. The size of a chunk as well as the size of a value blob may affect the cost of blob maintenance, key management, time to transfer data from persistent storage into memory, and time to inflate the data into in-memory data structures. All the data in a chunk may be retrieved from storage and loaded into memory together. The relative portion (i.e., percentage, ratio, etc.) of data within a chunk that is needed to evaluate a particular query may decrease as the size of the chunk increases. This relative portion may be referred to herein as a “hit rate”. As new data is added to the persistent data store, background processes optimize the hit rate by packaging and distributing data items into blobs to achieve maximum computation speed. The goal is to minimize the number of blobs read into memory in response to a query while minimizing the number of bytes read that will not be used to satisfy the query. The new data items may be added to/combined with another chunk of data items, and the key/value pairs updated to reflect the new distribution of data. This process is essential to achieving maximum performance from the system.

Blob storage manager 110 is capable of creating multiple views of the data items. A data item may have multiple attributes. For example, in the tweet example above, a tweet has three attributes: time, location, and text. Views may be created that correspond to the values of one or more of the attributes. A range of values for a particular attribute is referred to as a dimension. For example, a time dimension may comprise the range of time between Dec. 25, 2011 and Jan. 1, 2012. Data items may be accessed through a particular view that corresponds to a dimension. For example, the query may be processed by retrieving all tweets that were sent between Dec. 25, 2011 and Jan. 1, 2012, and the tweets retrieved through the time view may then be filtered to identify those tweets that originated from Nevada. Alternatively, the query may be processed by retrieving all the tweets that originated in Nevada through the location view, and these tweets may be then filtered to identify those that were sent between Dec. 25, 2011 and Jan. 1, 2012.

Each view may be organized optimally based on a specified chunking strategy. The amount of data pointed to by a key may be different in different views. For example, for data that largely flows sequentially through time at a high rate such as data recording events that occur frequently, the data items may be organized by the date/time at which the reported event occurred. An example chunking strategy may be that data created on the same day are stored together in a chunk and represented by the same key. Examples of data reporting on high frequency events may include tweets, stock transactions, and computer system logs. Simultaneously, however, the blob storage manager 110 may use a different chunking strategy for a different view of the data. For example, different chunking strategies may be used for a location organization (such as from which state a tweet was sent, which stock exchange generated the stock transaction, or an IP address of the computer system generating a log record. For example, in the location view states may be grouped into regions and a key may be created to represent all the data pertaining to states in the same region.

Blob storage manager 110 is capable of optimizing how data items are distributed across blobs to account for observed characteristics of the persistent storage system, network, and de-serialization libraries. For example, it may be observed that it is faster to transfer over the network one blob that contains 10,000 data items than to transfer 10 files that each contain 1,000 data items. Additionally, it may be faster to de-serialize one list of 10,000 data items than 10 lists of 1,000 data items each. For those reasons, blob storage manager 110 may combine many small blobs into one larger blob. Also, blob storage manager 110 may break a blob that is too large into several smaller blobs. Blob sizes are maintained in a way so that inflating the data items contained within a blob does not exceed the amount of local memory (e.g., physical RAM) present on any one compute node. Continuously optimizing the packaging of ranges of data items is essential to the system achieving maximum performance in the case where data items are not found in memory and must be retrieved from the persistent storage system.

Blob storage service 150 stores new data items into a value blob and retrieves data items from value blobs. The blob storage service is implemented on the blob storage manager 110 that manages the persistent storage data structures such as the collection descriptors and value blobs. In response to a request to store a new data item, the blob storage service 150 identifies the attributes of the new data item that correspond to a data dimension for which a data view is provided. A copy of the data item is made to store within each corresponding data view. For each data view, the blob storage service may allocate a new value blob and store a copy of the new data item in the newly allocated value blob. A unique identifier is generated to identify the new value blob. When adding the new data item to an existing chunk, the generated unique identifier may be stored within the collection of data items (referred to hereinafter as the “collection”) in the collection descriptor associated with the key for the existing chunk. Alternatively, if the value blob is the first blob in a new chunk, a new collection descriptor may also be allocated for pointing to the new value blob.

Key management service 160 creates, names, updates, and identifies keys for the key/value store. Each data item is stored in one or more value blobs, and a collection descriptor stores a globally unique identifier for each of the value blobs used to store the data item. A key may be associated with a dimension of the data. Examples of data dimensions are time, location, and key words. For example, logged tweets may contain information regarding the location of the tweeter, the time the tweet was sent, and certain words in the message. Tweets having the same origination location may be grouped together and the group (collection) pointed to by a location key. Tweets sent within a certain time period may be grouped together and the collection pointed to by a time key. And tweets containing a certain keyword may be grouped together and the collection pointed to by the collection descriptor of a keyword key. Thus, data for a single event may be stored in multiple value blobs, i.e., one per dimension. Each key is named based on the values of the dimension with which the key is associated. For example, the key that represents tweets sent from Nevada may have “Nevada” in the name of the key. Keys that represent tweets sent within a certain time period of each other may have the time range included in the key name. The key management service 160 can identify keys associated with a collection descriptor that points to a collection of data having a requested dimension value.

To update a stored value, rather than changing data that has been previously stored within a value blob, a new value blob may be created to store the new value. Thus, data stored within a value blob is immutable. Other processes can continue to read the previous value for a key while the value is being updated.

The key management service 160 relies on the key management module 120 to provide atomic updates to data, and thus, provides immediate consistency. In an embodiment, the key management module 120 is implemented on an existing cloud infrastructure that provides a key value store with atomic update. For example, the key management module 120 may rely on the key value store provided by Amazon's Dynamo key store.

In another embodiment, key management module 120 may be implemented on an infrastructure that does not provide atomic update of keys, and thus, atomic update may be provided by the key management module 120 itself. In an embodiment, a collection descriptor associated with a key may be implemented using key blobs. That is, a blob of storage may be allocated for storing a collection of data item pointers that point to value blobs, referred to herein as a collection descriptor.

Updating a key blob may comprise taking a “lease” on the key which provides mutual write exclusion of the associated key blob. The unique identifier of the new value blob is inserted into the key blob, then the lease is released. While an update operation has acquired a lease on the key, new requests for the key will receive read-only access to the key for the purpose of reading a previous version of the values, and other processes already having a copy of the key are free to read any previous version of the values without blocking. Once the lease is released, requests for the most recent value of the key will return the new value. The only operations that must wait on a key under lease are other write operations to the associated key blob. However, inserting or changing data with values within the same value range is only blocked during the time it takes to add a global identifier into the key blob. This ensures that values are updated sequentially with minimal blocking.

The key management service 160 also supports versioning of data. Metadata regarding the version of the data may be stored within the collection descriptor. In an embodiment, when a user wants to update the value of a data item pointed to by a key's collection descriptor, the user can specify the version that was modified to create the new version. The key management module 120 may validate that the version stored in the metadata of the current collection descriptor is still the version on which the new value was based. If the versions match, then the collection descriptor may be updated to point to the new value blob. If the versions do not match, the user may be informed that the modification needs to be performed on an updated version, and the collection descriptor may not be updated.

The key management service 160 also supports persistent versioning of data. Because all data ever written to the system is immutable and remains in persistent storage, and because each collection descriptor keeps a history of which value blobs are pointed to for each version number that the key has advanced to, it is possible to retrieve the values for a key at a certain version number. Because of the distributed nature of the system, this is important to ensure that each node participating in a query receives the same values for any given key. This is accomplished by specifying the key and the version number when distributing subquery computations across processors. If the value for a key is modified during a query the processing of the query may not be affected because updates made to the data as a result of processing the query may result in a new version of the key while any nodes accessing the key may be working with the previous version.

Query manager 140 is part of a massively parallel query engine that performs queries received from an external device over the network connection. Each query request contains three distinct parts: a definition of the data set on which to perform a calculation, the calculation to perform on the selected data items, and the merge function that combines results from partial results from multiple subqueries into the ultimate response. Query manager 140 determines on which dimension to perform the query to minimize the cost of query evaluation. In other words, the query manager 140 selects a data view through which to load serialized data items from persistent storage into inflated data items in memory. The query manager 140 considers the size of each data view and the expense of filtering the view to evaluate the query. Whereas loading the data view with the smallest number of items may lead to the least expensive query plan, if the processing needed on the smallest data view is very expensive, then another data view that may be larger may lead to an overall lower cost. The presence of data already in memory across various processors may also be considered. For example, if a view is already cached, the cost to execute a query on that dimension would not include the cost of transferring and inflating the data items into memory.

The query manager determines which processor nodes will be used to evaluate the query and assigns collections of data (subset) for each involved processor to scan and evaluate In an embodiment, keys are partitioned across processors such that any particular chunk may only be loaded into and/or inflated in a particular node's local memory. The query manager retrieves the keys representing the data in the selected view on which each processor node will evaluate its assigned subquery. Sub-sections of the keys may be distributed to the selected processor nodes along with the data set definition and the calculation to perform the assigned subquery computation. Processor nodes are selected using a technique where key names may be mapped to distinct compute nodes. Each processor node receiving instructions from the query manager 140 identifies the data set already present in memory or loads its sub-section of the data set into memory, either from a local cache or by retrieving it from the blob storage manager. Once in memory, each node identifies the valid data items by applying the data set definition. (see the description of de-serialization library generator 130). The query manager may receive the partial results from each of the processors involved in query evaluation and, using the merge function provided in the query, combines the results into the final query result to be sent back to the external device.

Serialization is the process of converting a data structure into a format that can be stored or transmitted across an I/O link. De-serialization is the opposite operation: extracting a data structure from a series of bytes. De-serialization library generator 130 takes as input a data type definition and generates instructions for de-serializing a data item of the defined type (also called inflating, unmarshalling, or instantiating the data item). The instructions may be binary machine-executable code or symbolic code that is interpreted by a processor. The library generator may use a type definition compiler. As a result of executing the library code on a byte stream, the data in the byte stream may be interpreted as a data item of the defined type, and an object of the defined type may be created in memory.

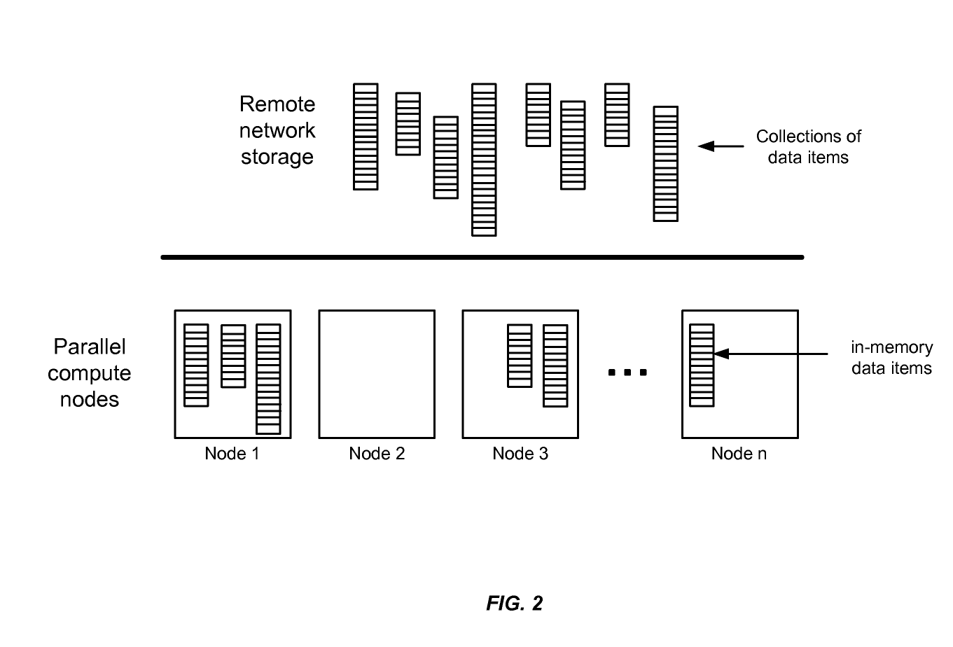

FIG. 2 is a simplified functional block diagram illustrating the relationship between collections of serialized data items stored in remote network storage and data item objects stored in memory that may be associated with parallel compute nodes. Each object corresponds to a serialized data item that has been inflated, according to an embodiment. The collections of data items depicted in the remote network storage area are collections of value blobs storing serialized data items. Each collection may be pointed to by a collection descriptor. The processor nodes depicted as blue boxes within the parallel compute nodes can be requested on demand, for example, for processing a query over the data stored in the remote network storage. When a node is instructed to perform a computation on a data item stored in persistent storage, the data item is copied into memory and inflated into an object in memory that is accessible to the processor node. This may be a processor-private memory or it may be a memory shared across the parallel compute nodes. The in-memory data items shown within the processor nodes are instantiated data types populated with data retrieved from persistent store and inflated. At the snapshot in time represented in the example, nodes 1 through n cache 3, 0, 2, and 1 number of collections of data items respectively.

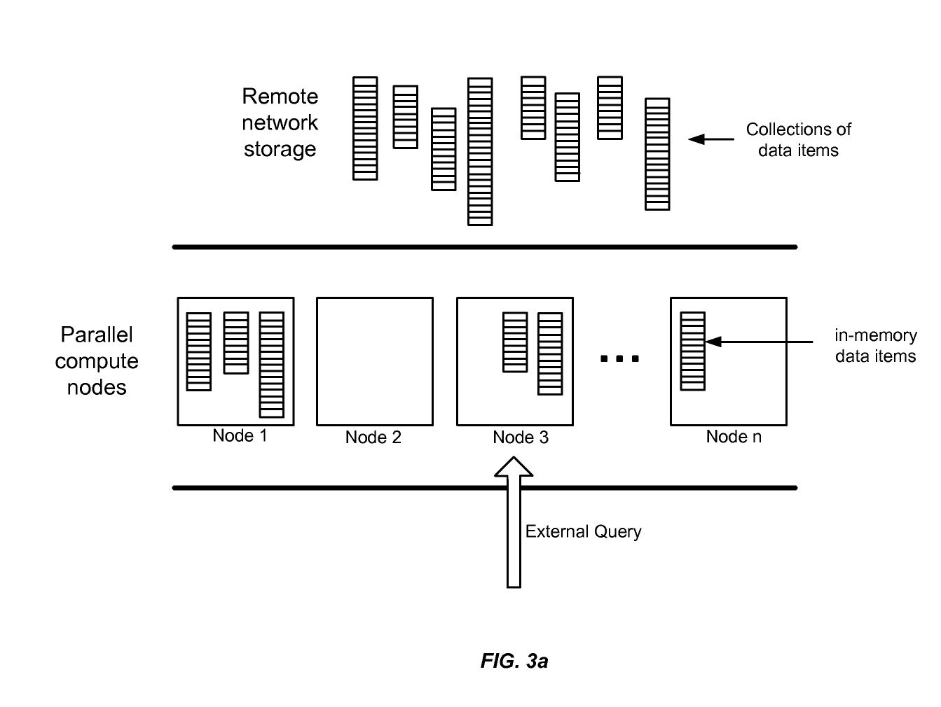

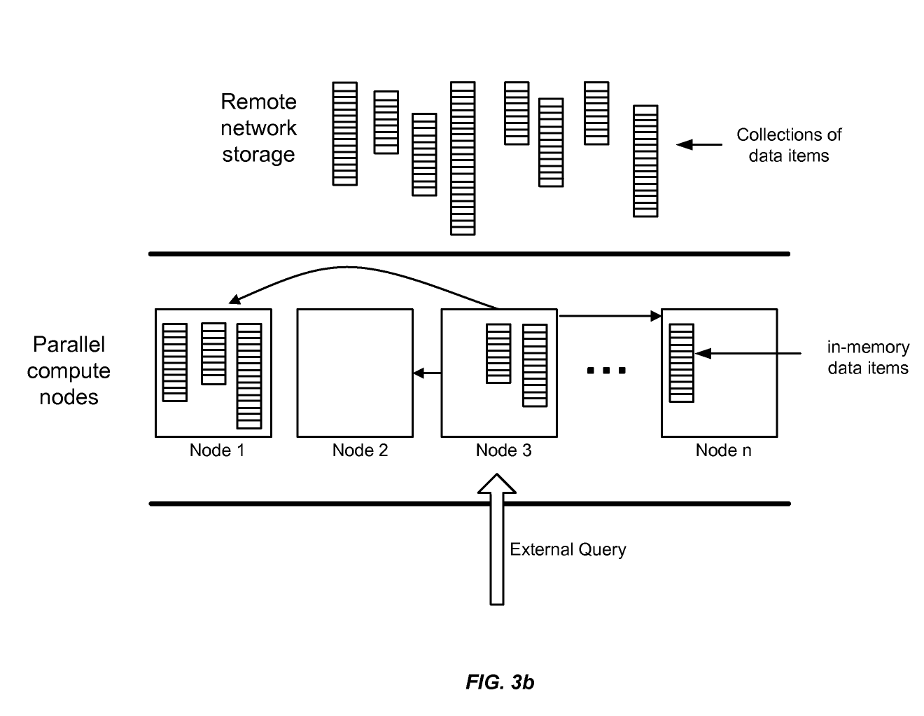

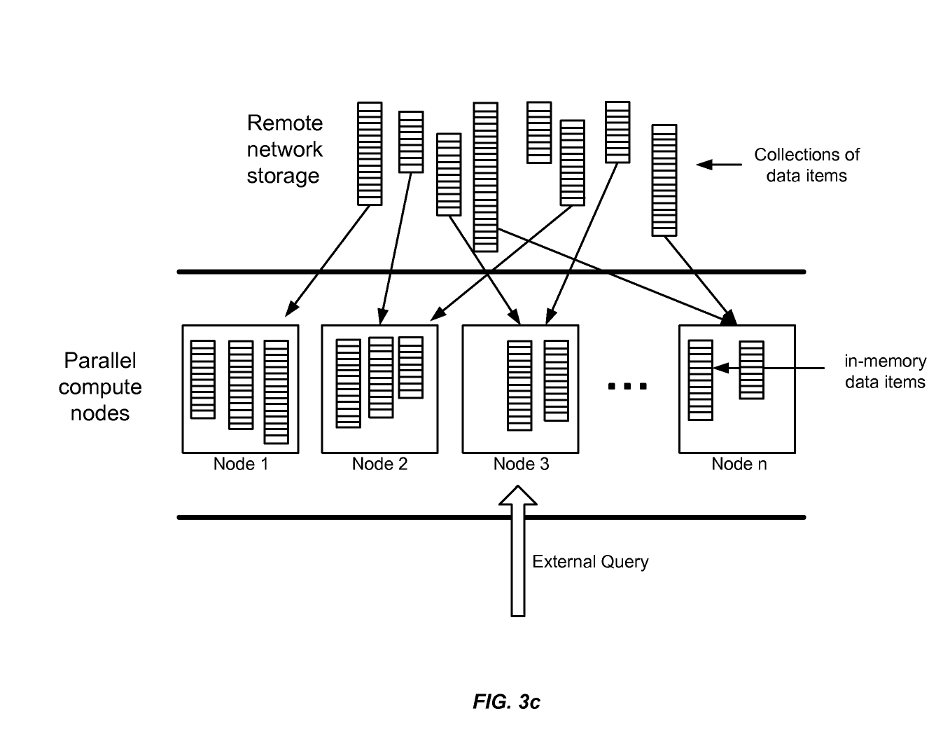

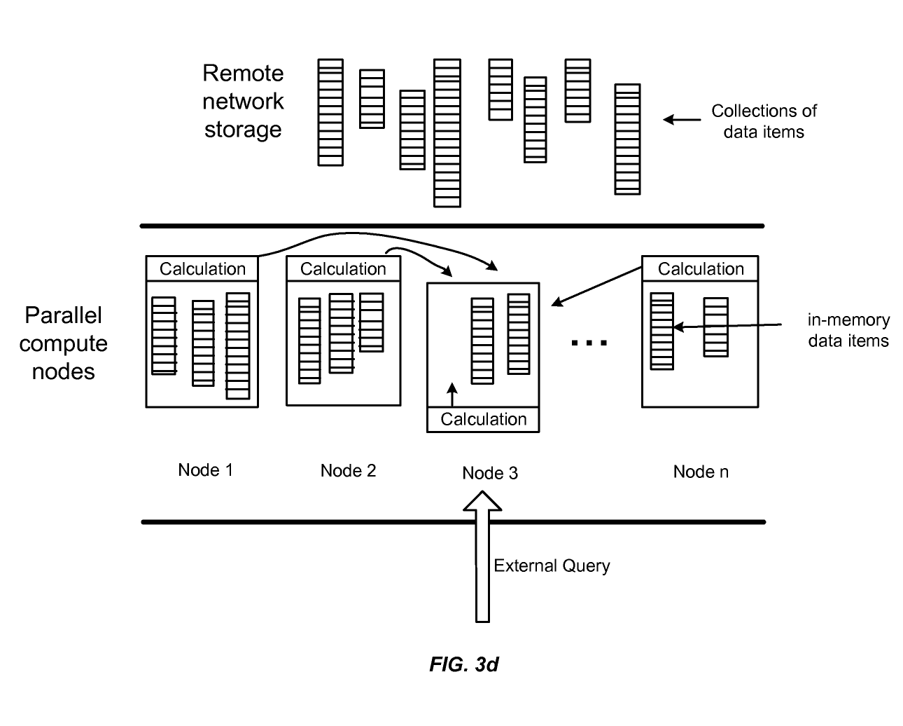

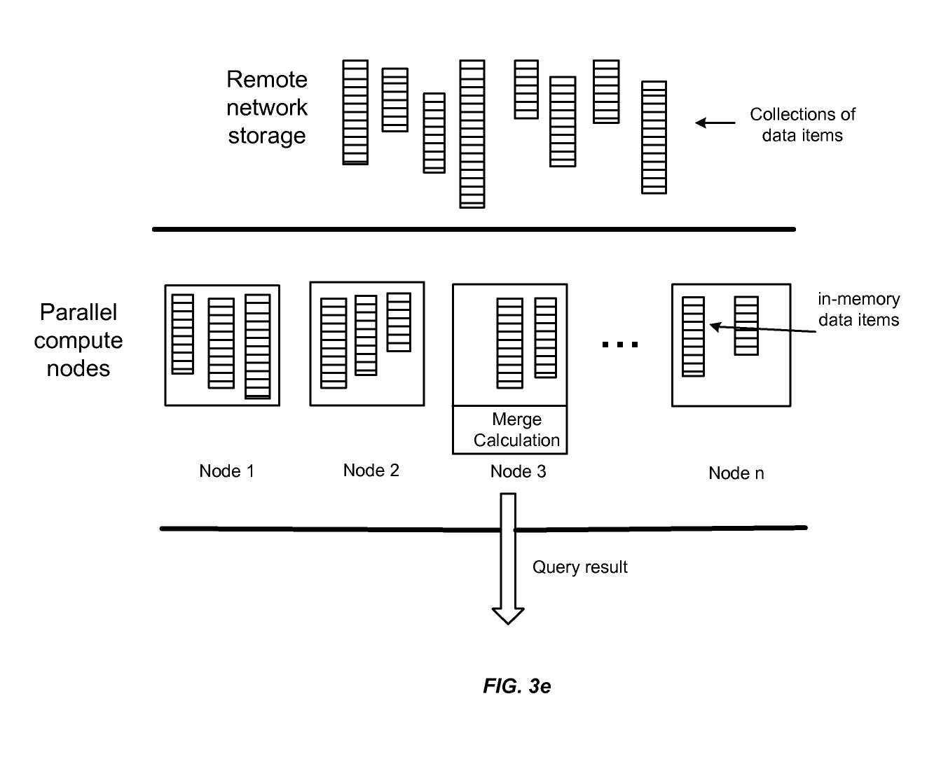

FIG. 3a is a simplified functional block diagram of an embodiment of a cloud computing system receiving an external query. In the example, node 3 receives an external query, and thus, node 3 is the initiating node and serves as the query manager for the incoming query.

FIG. 3b is a simplified functional block diagram of an embodiment of an initiating node in a cloud computing system distributing work to other processing nodes for evaluating the incoming query. In the example, the query manager selects nodes 1, 2, and n to each perform part of the query evaluation and distributes instructions to them. In an embodiment, the processors are selected based on the presence of objects in memory that are required to evaluate the query. In an embodiment, the query manager may determine which keys to assign to which processor nodes by computing an integer hash code from the key's name and doing a modulo calculation with the number of nodes (hashcode % numberNodes). The number produced may identify the number of a processor to which the key may be assigned. This may ensure smooth distribution of data across the nodes (by having a good hashing algorithm). In an embodiment, the instructions sent to each selected processor node include at least a set of keys representing the data items for that node to evaluate, the definition of the structure of the data to be evaluated, and the computation to perform.

FIG. 3c is a simplified functional block diagram of an embodiment of processor nodes in a cloud computing system retrieving data for performing the work assigned by the initiating processor node. In the example, node 1 is assigned to process one collection of data items and nodes 2, 3, and n are each assigned to scan two collections each. In an embodiment, each data collection to be used in the query may be assigned to only one of the processing nodes. The arrows from a collection of serialized data items in persistent storage to a memory accessible by a processor node indicates that the serialized data is retrieved from the persistent store and instantiated in the corresponding processor-accessible memory.

FIG. 3d is a simplified functional block diagram of an embodiment of processor nodes in a cloud computing system sending results of the work performed on each node back to the initiating node. The example shows each processor node performing their assigned computation on the data retrieved from storage and sending back the results of that computation as partial results for the received query.

FIG. 3e is a simplified functional block diagram of an embodiment of an initiating node in a cloud computing system collecting results from each processor node, merging these results, and returning query results in response to an external query. Merging results may involve aggregating the partial results. For example, if the query was to determine how many companies' common stock price rose on a particular date, each processing node may be instructed to process a subset of stock records for the particular date and identifying a number of distinct companies whose stock price went up, or alternatively, each processing node may be instructed to process stock records for a particular company, scanning the records for those that occurred at the end of the particular date. In either case, the partial results determined by each processor node are added together to provide results for the overall query. In another example, the query may request the closing price for each company's common stock that closed up on the certain date. To satisfy the incoming query, the query manager has to merge the set of partial results supplied by each of the processing nodes. As another example, when performing the example weather query, each processor node may return the average temperature for the desired week for a subset of weather stations, and merging the results may comprise joining the sets of average temperatures returned by each of the processors. For the stock trading example described above, each processor node may return the highest price paid for AAPL stock within an assigned time period before Dec. 31, 2011, and the merge may comprise selecting the maximum value of all the results returned.

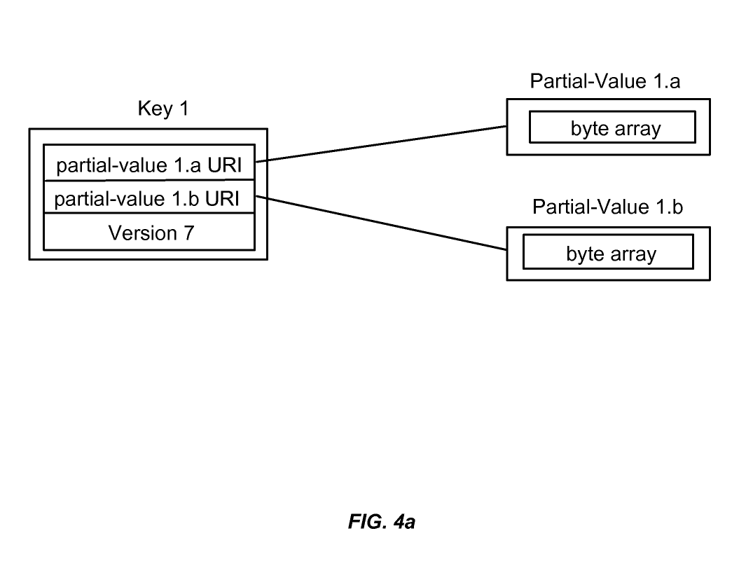

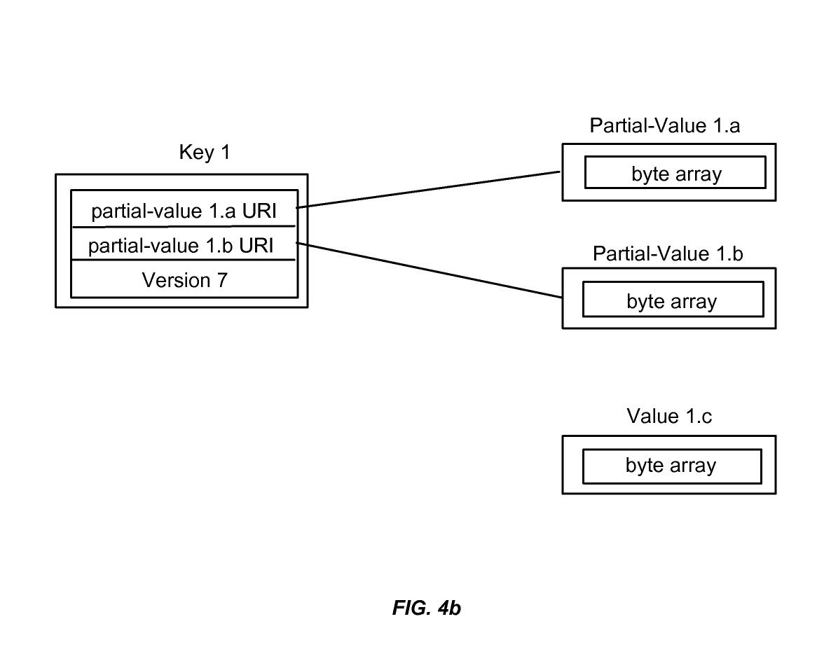

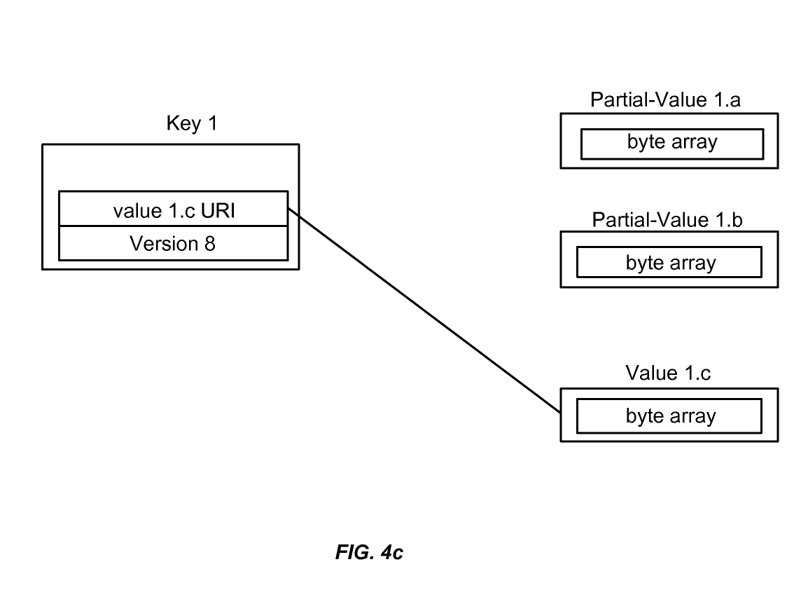

FIG. 4a is a simplified functional block diagram of an embodiment of a collection descriptor representing a set of serialized data items that is stored across two value blobs. Each value blob stores one or more serialized data items. For example, one value blob may store tweets sent between 10:00 am and noon on a particular day, and another value blob may store tweets sent between noon and 2:00 pm on the same day. The collection descriptor associated with a key that represents tweets sent on the particular day may point to both of the two value blobs.

The collection descriptor contains a unique identifier for each of the value blobs that the collection descriptor points to. In the embodiment illustrated in FIG. 4a, the unique identifier stored in the collection descriptor is a uniform resource identifier (URI). However, other unique identifiers may be used. A collection descriptor containing two URIs may refer to a collection of two serialized data items. In an embodiment, every data item is completely stored within a single blob. In an alternate embodiment, two or more value blobs may each store a partial value that together comprises a single serialized data item. In other words, more than one data blob may be needed to retrieve the data item value. The collection descriptor also contains a version number.

FIG. 4b is a simplified functional block diagram of an embodiment of combining the contents of two value blobs into one new value blob. One common example where this may happen is when the value 1.a and value 1.b are consolidated within a single, larger value blob 1.c. to optimize access performance. Each value blob contains a serialized list of data items. To combine value blobs, the serialized data in each blob (1.a and 1.b) is first de-serialized, the de-serialized data from each blob is combined into a single list, and the new combined list of data items is serialized and stored in a new value blob (1.c).

FIG. 4c is a simplified functional block diagram of an embodiment of updating the collection descriptor to point to the new value blob. In an embodiment, a lease is taken on Key 1 which provides mutually exclusive write access to Key 1's collection descriptor. The URI identifying the new value blob containing value 1.c replaces both URIs identifying the value blobs storing value 1.a and value 1.b. The version number is updated to version 8 to reflect that the key data has changed. The lease is then released.

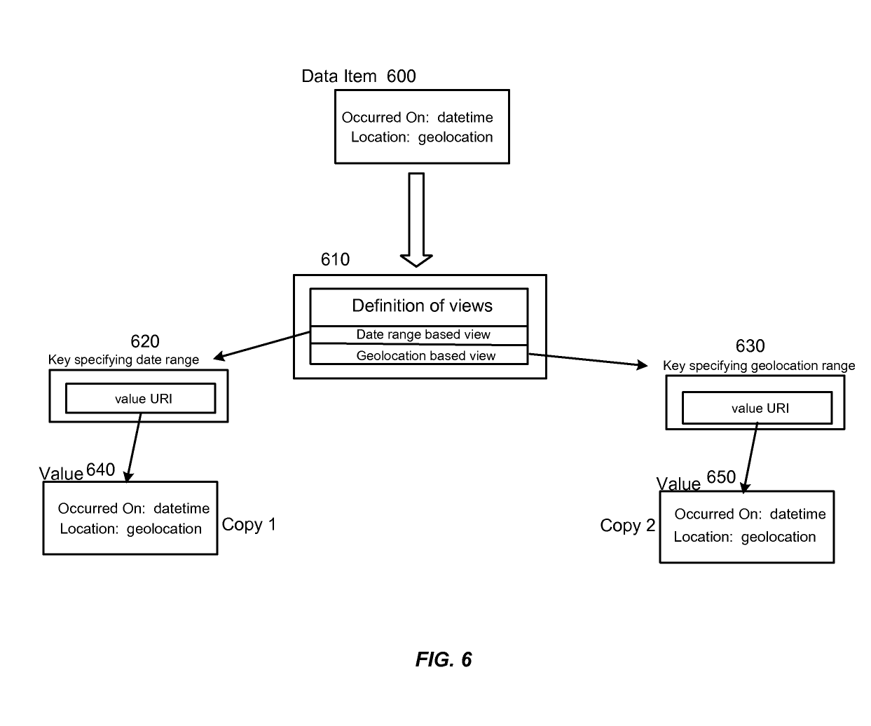

FIG. 6 is a simplified functional block diagram of an embodiment of storing a data item with two attributes: time and location. A copy of the serialized data item is stored in a value blob that is placed into a chunk included in a time view and another, separate copy of the serialized data item is stored in another value blob that is placed into a chunk included in a location view. The new serialized data item 600 is to be stored in persistent storage. The new serialized data item 600 contains a value indicating when an event occurred (date/time dimension) and value indicating where the event occurred (geolocation dimension). A definition of views 610 is consulted to find the keys associated with these two dimensions so that the new data item may be added to each corresponding data view. Key 620 corresponds to a date range view that is associated with the date/time dimension. Key 630 corresponds to a geolocation range that is associated with the geolocation dimension. Value blobs 640 and 650 are each allocated to contain a serialized copy of data item 600, and value blobs 640 and 650 are allocated distinct universal identifiers, each of which is stored within the collection descriptor of their respective keys. A universal identifier may be a URI or a globally unique identifier (GUID).

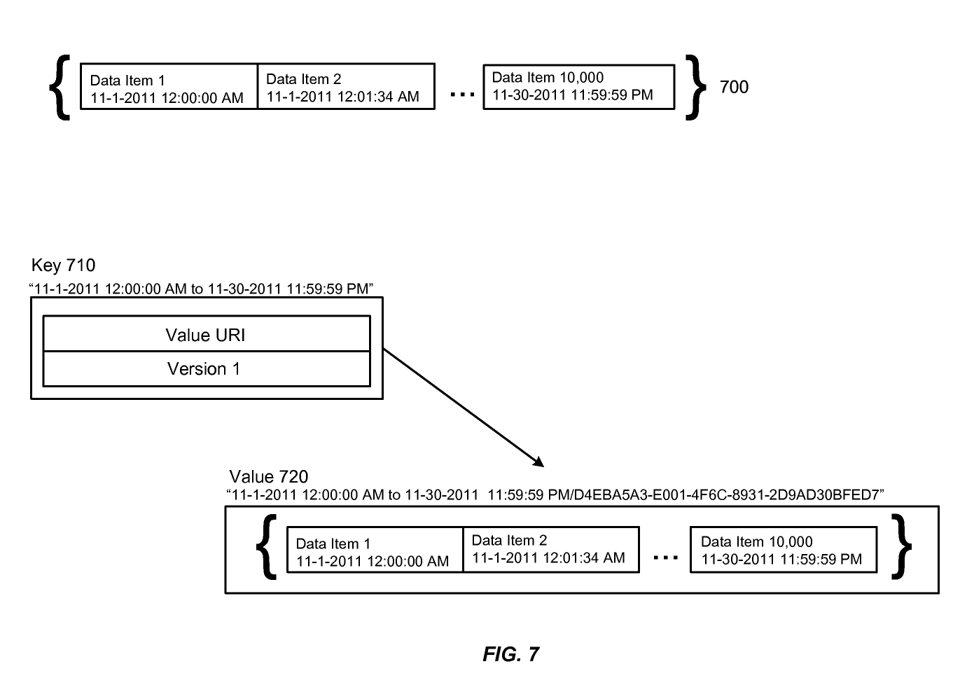

FIG. 7 is a simplified functional block diagram of an embodiment of a key naming convention. In the example, serialized data items 1 through 10,000 are stored within the same value blob. Each serialized data item of the 10,000 serialized data items contains a timestamp. The example illustrates a key for the date time range data view. The key name is generated based on the earliest and latest time stamp of the serialized data items stored in the blob. In the example, the earliest timestamp is Nov. 1, 2011 at midnight and the latest timestamp is Nov. 30, 2011 at one minute before midnight. Thus, the date time range is “11-1-2011 12:00:00 AM to 11-30-2011 11:59:59 PM”, and this date range is assigned as the key name. The Value URI assigned to the value blob is the key name with a globally unique identifier (GUID) appended to the end.

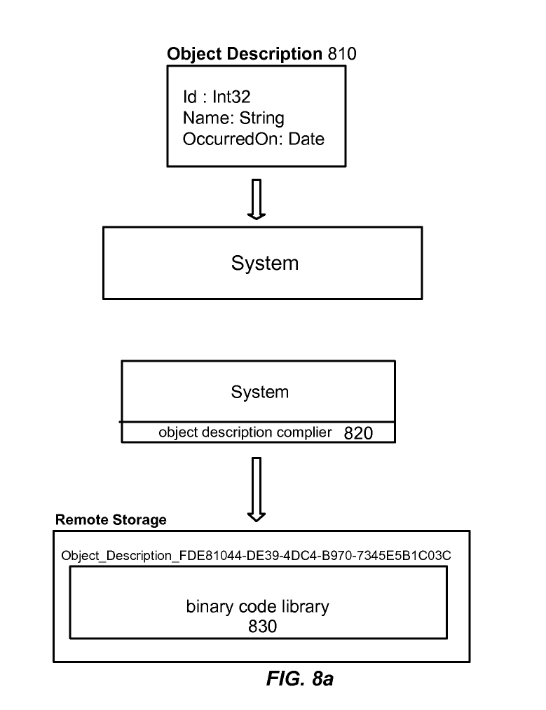

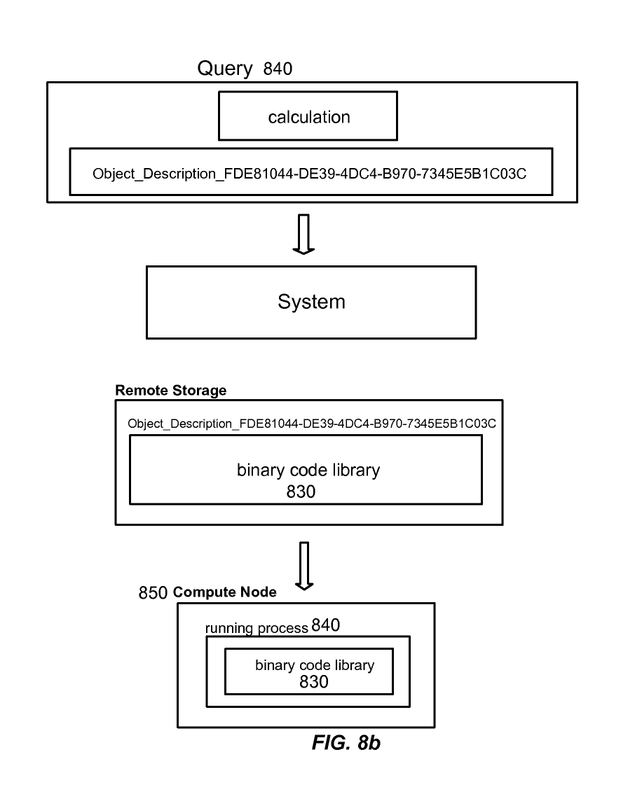

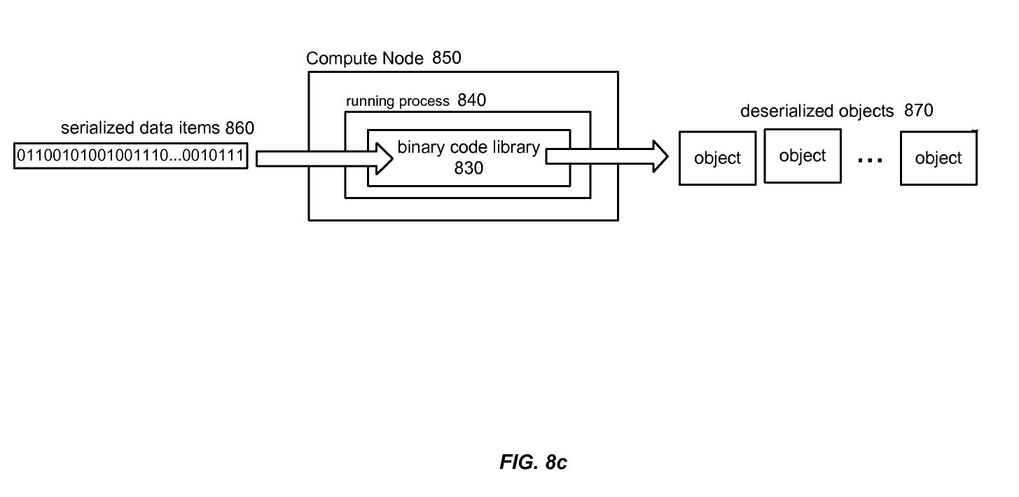

FIG. 8a is a simplified functional block diagram of an embodiment of generating and storing a de-serialization library from a description of a data item type. Object Description 1010 is a textual description of the structure of a data type. The object description may be expressed as Apache Thrift, or any other text-based data definition language such as XML schema, data type definition (DTD), or custom data structure definition language. The de-serialization library generator, upon receiving object description 1010, runs the object description compiler to generate a binary code library 1030 for execution on a processor. The binary code library 1030 may be stored in a value blob with a URI comprising of a globally unique identifier appended to “Object_Description”. In an embodiment, the de-serialization library may be generated in response to Object Description 1010 being registered with the system. In an alternate embodiment, the de-serialization library may be generated the first time a processor node needs to retrieve a data item of the type described in the Object Description 1010. If the library does not already exist, a processor node may create it.

FIG. 8b is a simplified functional block diagram of an embodiment of a compute node retrieving a de-serialization library from persistent storage, and loading the library into the compute node's local memory. When a query is received and compute node 1050 receives instructions to perform a computation on a data item object, the binary code library 1030 that was generated from the description of the data item's type is retrieved into memory into running process 1040 executing on compute node 1050.

A value blob, as it resides in the storage system, is treated as a series of bits with no structure. The data item objects created by the binary code library have distinct boundaries and their structure is known, allowing for proper interpretation necessary for computation. For example, if a query requires comparing an attribute value to a constant (e.g., date before Dec. 31, 2011), the location and format of a timestamp within the data item object must be known.

FIG. 8c is a simplified functional block diagram of an embodiment of using the de-serialization library to de-serialize serialized data items from persistent storage into data item objects memory. The serialized data items are input into the running process 840 and the binary code library de-serializes the data items into one or more distinct objects. For example, the value blob 820 that contains serialized data for 10,000 data items may be input into the running process, and 10,000 objects may be created, each object representing a data item. The library may evaluate value blob 820 in a streaming manner. The serialized data may be streamed, and thus, not much memory needs to be allocated for the serialized data. In an embodiment, all serialized data items stored within a common chunk, when inflated, may fit within the local processor memory. In an alternate embodiment, all serialized data items stored within a value blob may fit within the local processor memory, but the data across all blobs within a chunk might not. For example, in an embodiment a first blob may be read, the serialized data items inflated, and evaluated before subsequent blobs are read and evaluated. Alternatively, retrieving the data from a subsequent blob may be performed concurrently with the evaluation of data item objects from a previously retrieved and inflated blob.

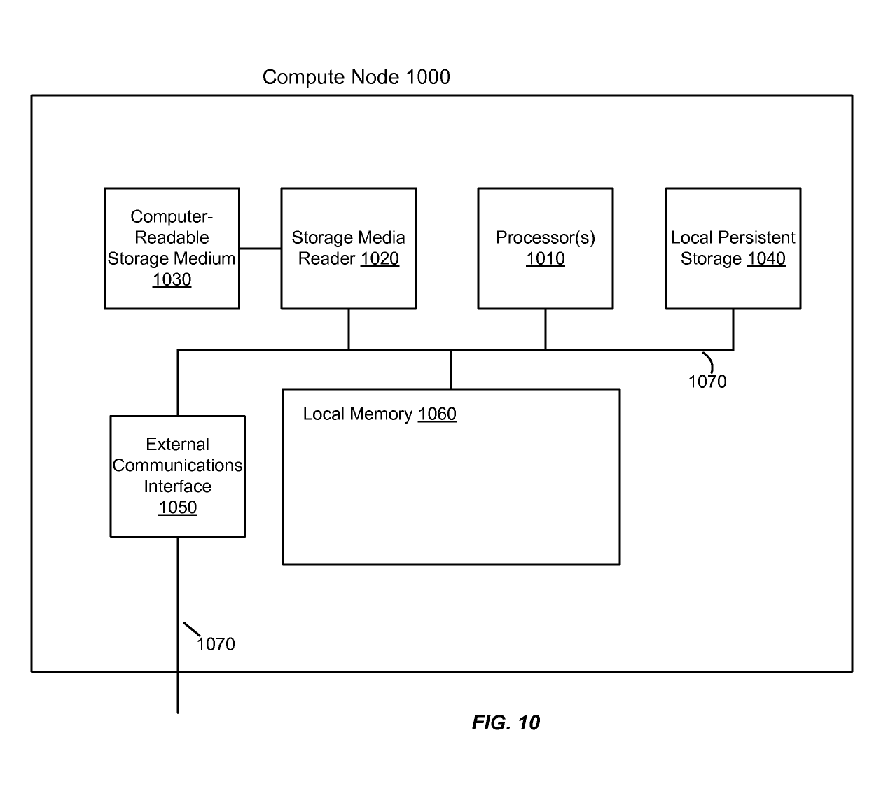

FIG. 10 is a simplified functional block diagram of an embodiment of a computing system on which the techniques herein may be implemented. FIG. 10 illustrates a compute node 1000 of the set of compute nodes 910. Compute node 1000 includes a local memory 1060, such as a random access memory (RAM) or other dynamic storage device, for storing information and instructions to be executed by one or more processors 1010. Compute node 1000 may contain a local persistent storage device 1040, such as a magnetic disk or optical disk, in addition to storing and retrieving data to/from a network-attached storage residing within the cloud.

The techniques described herein may be implemented using compute node 1000. According to one embodiment of the invention, the techniques are performed by compute node 1000 in response to the one or more processors 1010 executing one or more sequences of one or more instructions contained in local memory 1060. Such instructions may be read into local memory 1060 by storage media reader 1020 from a non-transitory machine-readable storage medium, such as computer-readable storage medium 1030. Execution of the sequences of instructions contained in local memory 1060 causes the one or more processors 1010 to perform the described functions. In alternative embodiments, hard-wired circuitry may be used in place of or in combination with software instructions to implement embodiments of the invention. Thus, embodiments are not limited to any specific combination of hardware circuitry and software.

The term “computer-readable medium” as used herein refers to any medium that participates in providing data that causes a machine to operate in a specific fashion. Such a medium may take many forms, including but not limited to, non-volatile media or volatile media. Non-volatile media includes, for example, optical or magnetic disks, such as local persistent storage device 1040. Volatile media includes dynamic memory, such as local memory 1060.

Common forms of machine-readable storage media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other non-transitory medium from which a computer can read.

Compute node 1000 also includes an external communications interface 1050. communications interface 1050 provides a two-way data communication coupling to a network link 1080 that is connected to a local network. For example, external communications interface 1050 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, external communications interface 1050 sends and receives electrical, electromagnetic or optical signals that carry digital data streams representing various types of information.

Compute node 1000 can receive and send data through communications interface 1050. For example, a database query may be sent from data center 950 and received by compute 1000 through data communications interface 1050.

Compute node 1000 includes a bus 1070 or other communication mechanism for enabling compute node modules to communicating with each other, and one or more processors 1010 for processing information. Storage media reader 1020, the one or more processor 1010, local persistent storage 1040, local memory 1060, and external communications interface 1050 are each coupled to bus 1070 for communication internal to compute node 1000.

Persons skilled in the art will recognize that many modifications and variations are possible in the details, materials, and arrangements of the parts and actions which have been described and illustrated in order to explain the nature of these embodiments and that such modifications and variations do not depart from the spirit and scope of the teachings and claims contained therein.

1. A cloud computing system comprising:
a plurality of processor nodes, each processor node having access to a local memory device and persistent storage devices;
a blob storage service implemented on the persistent storage devices;
the blob storage service operable to store a plurality of value blobs, each value blob of the plurality of value blobs containing one or more serialized data items;
a key management service operable to store a plurality of keys, each key of the plurality of keys associated with a collection descriptor comprising one or more unique value blob identifiers.

2. The cloud computing system of claim 1,
wherein a set of data items stored by the blob storage service have at least one common attribute and a first data item and a second data item of the set of data items are stored within a common value blob;
the blob storage service further operable to organize the common value blob along a dimension that corresponds to a range of values, the range of values including values of the at least one common attribute of the first data item and the second data item.

3. The cloud computing system of claim 2, wherein the set of data items stored by the blob storage service has a plurality of common attributes;
the blob storage service further operable to:
a) receive a request to store a new data item;
b) identify a plurality of dimensions relevant to the new data item, each dimension of the plurality of dimensions corresponding to an attribute of a plurality of attributes of the new data item; and
c) for each dimension of the plurality of dimensions:
1) allocate a new value blob associated with said each dimension;
2) store a copy of the new data item in the new value blob;
3) generate a unique identifier for the new value blob;
4) identify a particular key corresponding to a range of values in said each dimension, wherein the range of values includes the value of an attribute of the new data item, wherein said attribute corresponds to said each dimension; and
5) insert the unique identifier of the new value blob into the collection descriptor associated with the particular key.

4. The cloud computing system of claim 1, wherein a collection descriptor associated with a key further includes a version indicator that represents a version of the key, and the system further comprising:
a first process running on a processor node retrieving a first key associated with a range of values in a particular dimension, wherein the range of values includes a requested range of values, and a collection descriptor associated with said first key including a first version indicator;
a second process running on a processor node retrieving a second key associated with said range of values in said particular dimension, wherein a collection descriptor associated with said second key including a second version indicator;
wherein the first version indicator is not the same as the second version indicator; and
wherein the first process and the second process run substantially concurrently.

5. The cloud computing system of claim 1, wherein the key management service comprises a key management module operable to assign a name to a key that is associated with a range of attribute values for a particular attribute, wherein the key name is generated based on the range of values and a unique identifier;
wherein the range of values is based on values of data items stored in value blobs referenced by a collection descriptor associated with the named key.

6. The cloud computing system of claim 1, wherein the key management module is further operable to allocate a blob as a key blob, and store a collection descriptor associated with a key in the key blob.

7. The cloud computing system of claim 6, wherein the key management service is operable to issue a lease on a key, ensuring that the lease holder has exclusive access to update data stored in the collection descriptor.

8. The cloud computing system of claim 1, wherein data stored within a value blob is immutable in the value blob; and
adding a new data item having a value that lies within a range of values represented by a particular key comprises:
allocating a new value blob and storing the new data item in the new value blob;
creating a new version of the particular key; and
storing an identifier of the new value blob in the collection descriptor associated with the new version of the particular key.

9. The cloud computing system of claim 8, wherein a first identifier to a first value blob is stored in a collection descriptor for a first version of the particular key, and changing data stored within the first value blob comprises:
allocating a second value blob having a second identifier;
creating a copy of the first data stored within the first value blob, and changing the copy of the first data to create second data;
storing the second data in a second value blob;
creating a second version of the particular key;
replacing the first identifier with the second identifier in a collection descriptor associated with the second version of the particular key.

10. A cloud computing system comprising:
a plurality of processor nodes, each processor node having access to a local memory device and persistent storage devices;
a blob storage service storing data items having a plurality of dimensions;
a plurality of keys, each key of the plurality of keys corresponding to a particular dimension of the plurality of dimensions and identifying a collection of data items having the particular dimension; and
a query manager operable to:
a) determine a primary dimension referenced by a query expression;
b) identify a set of keys corresponding to the primary dimension;
c) select a set of processor nodes to evaluate a subquery of the incoming query;
d) assign each processor node of the set of processor nodes a set of keys corresponding to the primary dimension, wherein said each processor node evaluates the query expression over the collection of data items identified by each key in the set keys assigned to said each processor node.

11. The cloud computing system of claim 10, wherein
a first set of keys assigned to a first processor and a second set of keys assigned to a second processor are disjoint sets of keys.

12. The cloud computing system of claim 10, wherein
selecting the set of processor nodes includes selecting a particular processor node of the set of processor nodes based at least on presence of data item objects within local memory accessible to the particular processor node, wherein the data item objects are required to evaluate the query.

13. The cloud computing system of claim 10, wherein
determining the primary dimension comprises:
a) identifying a plurality of dimensions referenced by the query expression;
b) determining a cost to evaluate the query expression in each dimension of the plurality of dimensions referenced by the query expression;
c) selecting the primary dimension based on the cost to evaluate the query expression on each dimension;
wherein the primary dimension is a dimension corresponding to a data view,
wherein the data view comprises copies of each data item stored in a value blob that is organized along the primary dimension; and
evaluating the query expression comprises loading data into local memory from the data view corresponding to the primary dimension.

14. A cloud computing system comprising a blob storage manager that stores data items in a blob of a minimum size and a maximum size, wherein the minimum size and the maximum size are determined based at least on a size of local memory or performance data for inflating blobs of a plurality of sizes.

15. The cloud computing system of claim 14, wherein
the maximum size is further determined based at least on a size, when inflated, of the data items stored within a blob.

16. The cloud computing system of claim 14, wherein
the blob storage manager is operable to receive network performance data; and
the minimum size and the maximum size is determined based at least on the network performance data.

17. The cloud computing system of claim 16, wherein
the network performance data includes at least one of network bandwidth, latency, or error characteristics.

18. The cloud computing system of claim 14, wherein
the maximum size and the minimum size of a value blob used to store data items for a particular data view is further based on an access hit rate for the particular data view;
wherein the access hit rate for the particular data view is based on a number of data items referenced through the particular data view within a time period and a number of data items stored together within a value blob.

19. The cloud computing system of claim 14, wherein
a first maximum size and a first minimum size of a value blob used to store data items for a first data view is different from a second maximum size and a second minimum size of a value blob used to store data items for a second data view.

20. The cloud computing system of claim 14, wherein
the blob storage manager is further operable to:
discover an existing value blob that is larger than said determined maximum size; and
copy each data item stored within the existing value blob into a new value blob of a set of new value blobs, wherein a size of each new value blob is less than or equal to said determined maximum size.

21. The cloud computing system of claim 14, wherein
the blob storage manager is further operable to:
discover an existing value blob that is smaller than said determined minimum size; and
copy each data item stored within the existing value blob into a target value blob of a set of target value blobs, wherein the resulting size of each target value blob of the set of target value blobs is greater than or equal to the determined minimum size and less than or equal to said determined maximum size.

22. A cloud computing system comprising:
a plurality of processor nodes, each processor node having access to a memory device and persistent storage devices;
the persistent storage devices storing a plurality of value blobs, each value blob of the plurality of value blobs containing one or more serialized data items;
a data de-serialization library generator operable to:
a) receive a structure definition for a specific type of data item;
b) based on the structure definition, generate machine-executable instructions comprising a de-serialization library corresponding to the specific type of data item, which when executed, de-serializes a data item of the specific type; and
c) store the de-serialization library in a value blob; and
an object inflation module that, in response to a request to copy a particular data item from persistent storage into a memory device, is operable to retrieve from a value blob a de-serialization library for a particular data item type and execute the library to create and load a data item object into the memory device.
